(19) United States
(12) Patent Application Publication
(10) Pub. No.: US 2008/0098869 A1
(43) Pub. Date: May 1, 2008

(54) Electric punching device

(76) Inventor: Qinqi Chen, Shenzhen (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/905,631

(22) Filed: Oct. 3, 2007

(30) Foreign Application Priority Data
Oct. 31, 2006 (CN) 200620157869.8

(51) Int. Cl. B26D 1/12

(52) U.S. Cl. 83/669

(57) ABSTRACT

An electric punching device includes a driving transmission frame, a group of reamers and a driving board. The group of reamers are set on the driving board. The driving transmission frame includes a driving device and a transmission device, and the driving device includes a transmission shaft, a transmission shaft bracket and a transmission device and the transmission device is driven by a motor and drives the transmission shaft to turn. The motor and a motor bracket may cooperate with a gear, a lever, a strap or a chain, or the motor and the transmission shaft bracket may cooperate with the gear, the lever, the strap or the chain. When operating, the transfer performance and stability of the structure is good, space occupied is small, and cost is low.

### BACKGROUND OF THE INVENTION

1. Field of the invention

The present invention relates to an electric punching device belonged to office supplies, and more especially to a transmission frame of the electric punching device for driving.

2. Description of the Prior Art

At present, punching devices are used to punch on files or loose-leaves and include manual punching devices and electric punching devices. Although the manual punching devices are used widely, but users have to exert themselves to operate on the devices when they want to punch a pile of thick paper. However, the users' strength is not great enough to punch any holes sometimes, so the efficiency of such manual punching devices is low somewhat, and the users are prone to be tired. On the other hand, the known electric punching device' structure is complicated, volume is large, space occupied is also large, cost is high, and transfer performance is poor, stability of structure is low.

Hence, inventors of the present invention have this idea that the above shortages are able to be improved and finally suggest the present invention which is a reasonable design and an effective improvement basing on deep research.

### SUMMARY OF THE INVENTION

An object of the present invention is to provide an electric punching device, when operating, the transfer performance and stability of the structure are good, and space occupied is small, cost is low.

To achieve the above-mentioned object, an electric punching device is disclosed. The electric punching device includes a driving transmission frame, a group of reamers, and a driving board, wherein the driving transmission frame includes a driving device and a transmission device. The driving device includes a motor and the transmission device includes a transmission shaft, a transmission shaft bracket and a transmission component. The transmission component is driven by the motor and drives the transmission shaft to turn. The transmission shaft is set on the transmission shaft bracket, the driving board cooperates with the transmission shaft, and the reamers are set on the driving board.

Preferably, the transmission component includes an active component and a passive component, and the transmission of the transmission component is a gear transmission, a chain transmission, a strap transmission, a screw transmission or a cam lever transmission.

Preferably, the transmission component is a cylindrical gear, a conical gear, a worm, a gear train, an assembly of gear and strap or an assembly of gear and chain.

Preferably, the motor is set on the transmission shaft bracket to drive the active component, the active component drives the passive component, and the active component cooperates with the transmission shaft to drive the transmission shaft to turn.

Preferably, the driving device further includes a motor bracket, and the motor is set on the motor bracket to drive the active component set on the motor bracket or on the transmission shaft bracket.

Preferably, the active component and the motor are set on two sides of the transmission shaft bracket respectively, the motor drives the active component, and at least part of the passive component is set on the transmission shaft near to the transmission shaft bracket and cooperates with the active component.

Preferably, the active component and the motor are set on the two sides of the transmission shaft bracket respectively, and the passive component is set on one end of the transmission shaft and cooperates with the active component.

An advantage of the present invention is that the motor and the motor bracket may cooperate with a gear, a lever, a strap or a chain, or the motor and the transmission shaft bracket may cooperate with the gear, the lever, the strap or the chain. When operating, the transfer performance and stability of the structure is good, and space occupied is small, cost is low.

To further understand features and technical contents of the present invention please refer to the following detailed description and drawings related the present invention. But the drawings are only used to be references and explanations, not be limits to the present invention.

### BRIEF DESCRIPTION OF THE DRAWINGS

FIG. 1 is an isometric view of the first embodiment of the present invention;

FIG. 2 is an isometric view of the second embodiment of the present invention;

FIG. 3 is an isometric view of the third embodiment of the present invention;

FIG. 4 is an isometric view of the forth embodiment of the present invention;

FIG. 5 is an isometric view of the fifth embodiment of the present invention;

FIG. 6 is an isometric view of the sixth embodiment of the present invention;

FIG. 7 is an isometric view of the seventh embodiment of the present invention;

FIG. 8 is an isometric view of the eighth embodiment of the present invention;

FIG. 9 is an isometric view of the ninth embodiment of the present invention;

FIG. 10 is an isometric view of the tenth embodiment of the present invention;

FIG. 11 is an isometric view of the eleventh embodiment of the present invention;

FIG. 12 is an isometric view of the twelfth embodiment of the present invention;

FIG. 13 is an isometric view of the thirteenth embodiment of the present invention;

FIG. 14 is an isometric view of the fourteenth embodiment of the present invention;

FIG. 15 is an isometric view of the fifteenth embodiment of the present invention.

### DETAILED DESCRIPTION OF THE INVENTION

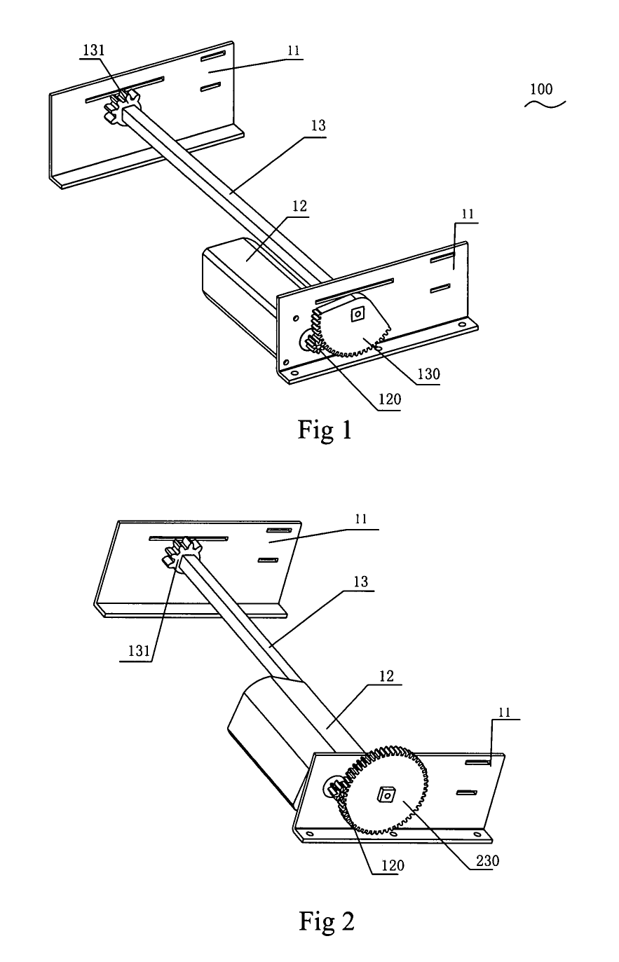

Please referring to FIGS. 1-28, a driving transmission frame 100 of the electric punching device of the present invention includes a driving device and a transmission device, and the driving device includes a motor 12. The transmission device includes a transmission component (a first transmission component), a transmission shaft bracket 11 and a transmission shaft 13. The transmission manner of the transmission device may be designed as a cylindrical gear transmission, a conical gear transmission, a worm transmission, a gear train, a chain transmission, a strap transmission, a screw transmission, and so on. The transmission component of the present invention includes a gear, a cam lever, an assembly of gear and strap or an assembly of gear and chain, and so on. A pair of parallel transmission shaft brackets 11 are set in underrmentioned embodiments, holes 333 are defined on the transmission shaft brackets 11 respectively, and sheathes 332 are set in the holes 333 respectively. The transmission shaft 13 is set into the holes 333 of the transmission shaft brackets 11 and may turn therein, the ends of the transmission shaft 13 are tightened by the sheathes 332, the transmission shaft 13 is perpendicular to the supporting panel of the transmission shaft brackets 11. Second transmission components are set near to the ends of the transmission shaft 13 (or other positions of the transmission shaft 13) inside of the transmission shaft brackets 11 respectively, and the second transmission component may be any known type. A gear 131 is adopted in underrmentioned embodiments to transfer the power from the driving transmission frame 100 to a punching tool. Which may be understood is that the transmission shaft brackets 11 may be a unitary frame having two parallel supporting panels, thus, the transmission shaft 13 may be set in the holes of the two parallel supporting panels.

Referring to FIG. 1, the gear transmission component of the embodiment includes a driving gear 120 and a driven gear 130, the driving gear 120 and the driven gear 130 joggle with, each other and are all cylindrical gears, and the driven gear 130 is one third gear. One end of the transmission shaft 13 penetrates one hole 333 of the transmission shaft brackets 11 and extends from the inside to the outside of the transmission shaft brackets 11, the driven gear 130 is set on the other end of the transmission shaft 13, and the motor 12 is set inside the transmission shaft brackets 11 and drives the driving gear 120 set outside the transmission shaft brackets 11. The driving transmission principle of the embodiment is that the motor 12 is set on the transmission shaft brackets 11 to drive the driving gear 120, the driving gear 120 drives the driven gear 130, and the driven gear 130 drives the transmission shaft 13 synchronously to make the transmission shaft 13 turn circularly, thus, the transmission function of electric single-driving is accomplished.

Which may be understood is that the driven gear 130 is not be limited at the one third gear, angle at the gear's circumference is satisfied so long as one time trip of the driven gear 130 accomplishes one time punch.

Differ from FIG. 1, a driven gear 230 of the second embodiment shown in FIG. 2 is an all gear, the structure and the work principle of the second embodiment is the same as that of the first embodiment.

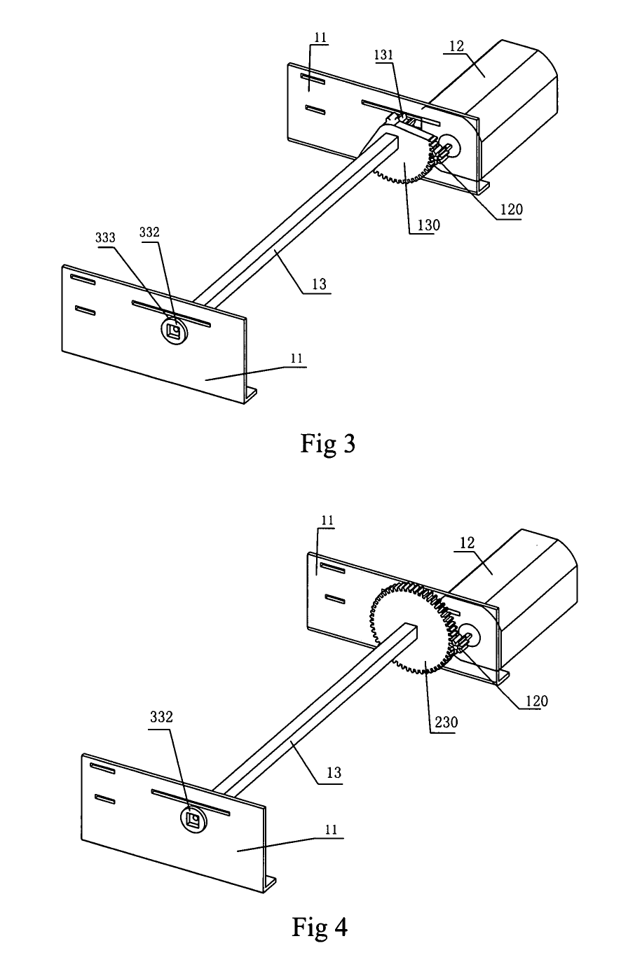

Differ from FIG. 1, the position of the motor 12 and the transmission component relative to the transmission shaft brackets 11 of the third embodiment shown in FIG. 3 is exchanged, that is to say, the motor 12 is set outside the transmission shaft bracket 11 and the driving gear 120 and the driven gear 130 are set inside the transmission shaft bracket 11.

Differ from FIG. 3, the driven gear 230 of the fourth embodiment shown in FIG. 4 is an all gear.

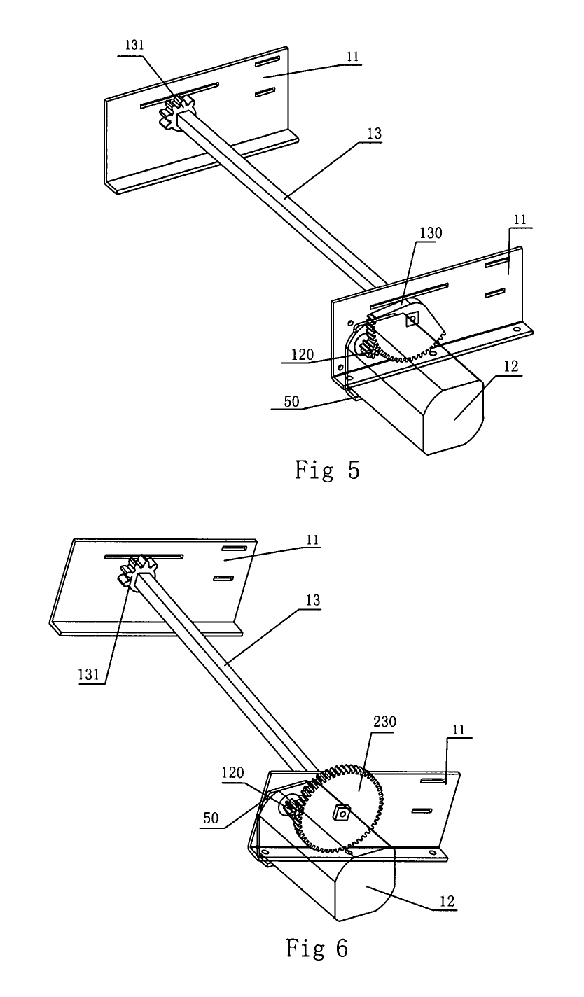

Please referring to FIG. 5 and FIG. 6, a motor bracket 50 is added in the driving transmission frame 100. The motor 12 is set on the motor bracket 50. In FIG. 5, the motor bracket 50 lies outside one of the transmission shaft brackets 11, the motor 12 is fixed on the motor bracket 50, the driving gear 120 is set between the motor bracket 50 and the transmission shaft bracket 11, the driven gear 130 is fixed on the transmission shaft 13 between the motor bracket 50 and the transmission shaft bracket 11, the driving gear 120 joggles with the driven gear 130, and the driving gear 120 is a cylindrical gear and the driven gear 130 is but not limited to one third gear. The ends of the transmission shaft 13 are fixed by the gear sheath 131. The driving transmission principle of the embodiment is: the motor 12 is fixed on the motor bracket 50, the motor 12 drives the driving gear 120, the driving gear 120 drives the driven gear 130, and the driven gear 130 drives the transmission shaft 13 synchronously to make the transmission shaft 13 turn circularly, thus, the transmission function of electric single-driving is accomplished.

Differ from FIG. 5, the driven gear 230 of the sixth embodiment shown in FIG. 6 is an all gear.

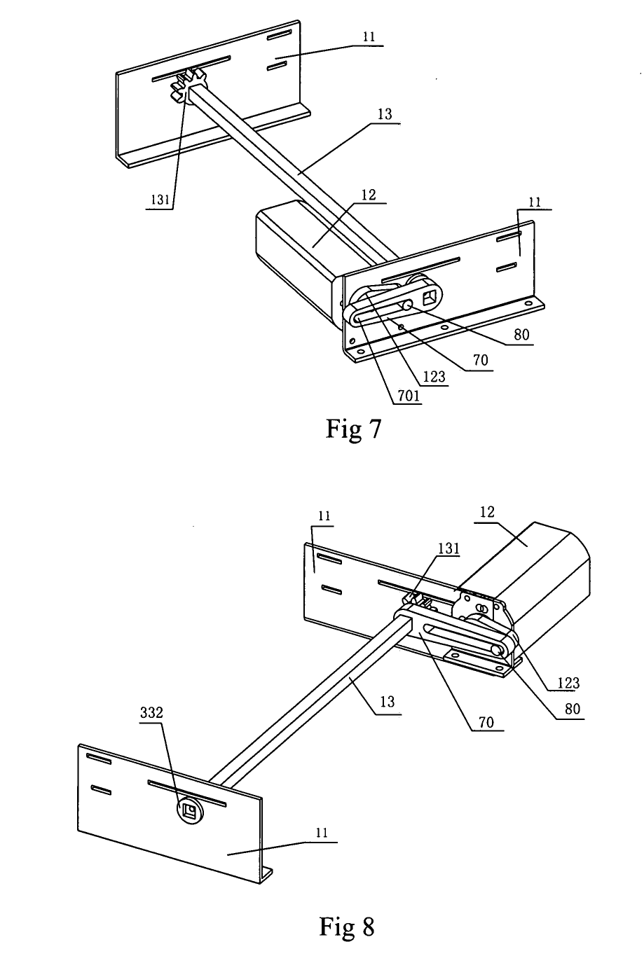

Please referring to FIG. 7, the transmission component of the seventh embodiment is a cam lever frame, an active component of the cam lever frame is a cam 123, and a passive component of the can lever frame is a lever 70. The lever 70 is fixed on the end of the transmission shaft 13 which extends outside the transmission shaft bracket 11. The cam 123 is set outside the transmission shaft bracket 11 and a tip 80 is set on the cam 123. A slot 701 is set on the lever 70. The tip 80 may glide in the slot 701. The motor 12 is fixed inside the transmission shaft bracket 11 and drives the cam 123, and the tip 80 of the cam 123 glides in the slot 701 and drives the lever 70 to turn synchronously to make the transmission shaft 13 turn circularly, thus, the transmission function of electric single-driving is accomplished.

Differ from FIG. 7, the position of the motor 12 and the transmission component relative to the transmission shaft bracket 11 of the eighth embodiment shown in FIG. 8 is exchanged, that is to say, the motor 12 is set outside the transmission shaft bracket 11, the cam 123 is set inside the transmission shaft bracket 11, and the lever 70 is set on the transmission shaft 13 inside the transmission shaft bracket 11.

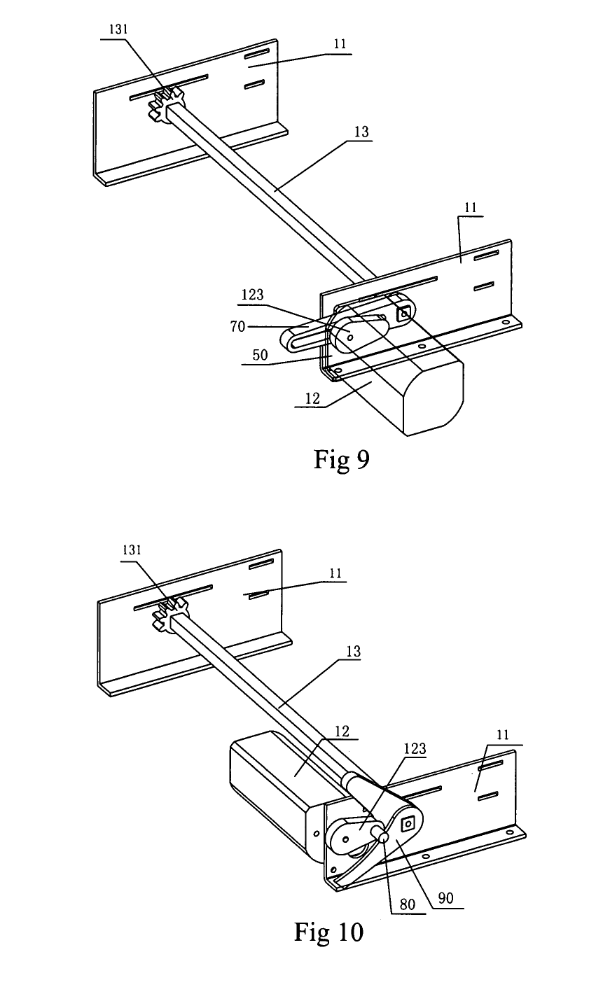

Differ from the FIG. 7, a motor bracket 50 is added in the driving transmission frame 100 of the ninth embodiment shown in FIG. 9. The motor bracket 50 is set between the transmission shaft bracket 11 and the motor 12, the motor 12 is set on the motor bracket 50, and the cam 123 is set between the motor bracket 50 and the transmission shaft b racket 11. The lever 70 is set on the transmission shaft 13 near to the outside of the transmission shaft bracket 11. The cam 123 is overlapped with the slot 701 and the tip 80 of the cam 123 may glide in the slot 701. The motor 12 drives the cam 123 to turn, the tip 80 drives the lever 70 to turn, and the lever 70 drives the transmission shaft 13 to turn.

Please referring to FIG. 10, the transmission component of the tenth embodiment is a cam lever frame, an active component of the cam lever frame is the cam 123, and a passive component of it is a lever 70. The cam 123 is set outside the transmission shaft bracket 11, and the tip 80 is set on the cam 123. A replacement block 90 is set on the lever 70, the lever 70 and the replacement block 90 are fixed on the end of the transmission shaft 13 which extends outside the transmission shaft bracket 11. The replacement block 90 and the tip 80 support each other. The motor 12 is fixed inside the transmission shaft bracket 11 to drive the cam 123, the cam 123 drives the lever 70 and the replacement block 90, and the lever 70 and the replacement block 90 drives the transmission shaft 13 to make the transmission shaft 13 turn circularly, thus, the transmission function of electric single-driving is accomplished.

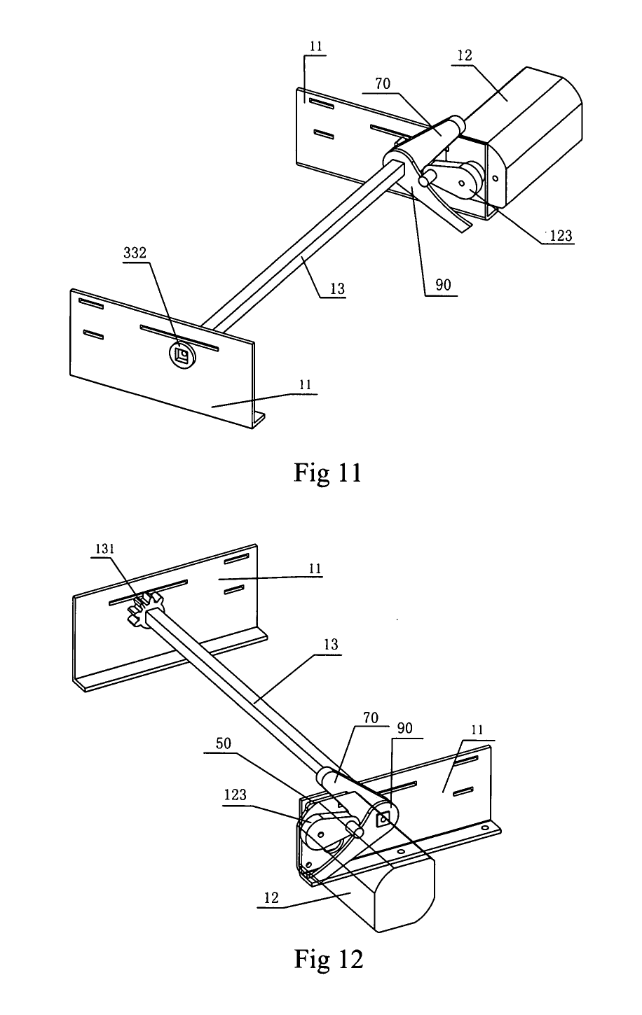

Differ from FIG. 10, the position of the motor 12 and the transmission component relative to the transmission shaft bracket 11 of the eleventh embodiment shown in FIG. 11 is exchanged, that is to say, the motor 12 is set outside the transmission shaft bracket 11, the cam 123 is set inside the transmission shaft bracket 11, and the lever 70 and the replacement block 90 are set on the transmission shaft 13 inside the transmission shaft bracket 11.

Differ from FIG. 10, a motor bracket 50 is added in the driving transmission frame 100 of the twelfth embodiment shown in FIG. 12. The motor bracket 50 is set between the transmission shaft bracket 11 and the motor 12, the motor 12 is set on the motor bracket 50, the cam 123 is set between the motor bracket 50 and the transmission shaft bracket 11, and the lever 70 and the replacement block 90 are set on the transmission shaft 13 near to the outside of the transmission shaft bracket 11.

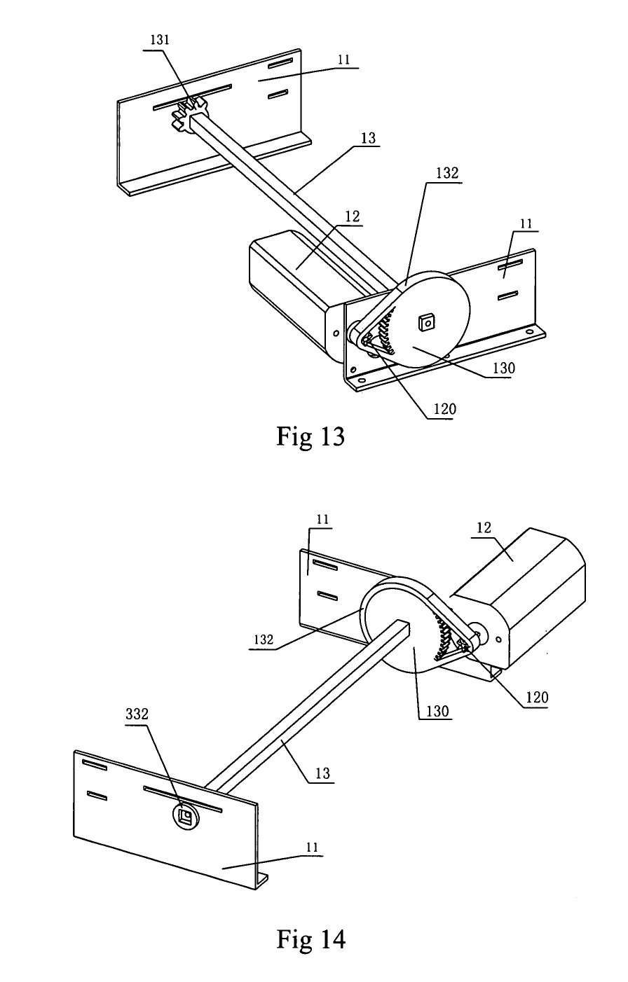

Please referring to FIG. 13, the motor 12 of the single-driving transmission frame 100 is set inside the transmission shaft bracket 11, the transmission component of the thirteenth embodiment is a cam lever frame, an active component of the cam lever frame is the driving gear 120, and a passive component of the cam lever frame is the driven gear 130. The driving gear 120 is a cylindrical gear, and the driven gear 130 is a cylindrical gear and set on the end of the transmission shaft 13 which extends outside the transmission shaft bracket 11. A connecting component 132 connects the driving gear 120 with the driven gear 130; and the connecting component 132 may be a strap or a chain. The motor 12 drives the driving gear 120, the driving gear 120 drives the driven gear 130 via the connecting component 132, and the driven gear 130 drives the transmission shaft 13 to make the transmission shaft 13 turn circularly, thus, the transmission function of electric single-driving is accomplished.

Differ from FIG. 13, the position of the motor 12 and the transmission component relative to the transmission shaft bracket 11 of the fourteenth embodiment shown in FIG. 14 is exchanged, that is to say, the motor 12 is set outside the transmission shaft bracket 11, the driving gear 120 is set inside the transmission shaft bracket 11 and is driven by the motor 12, the driven gear 130 is set on the transmission shaft 13 inside the transmission shaft bracket 11, and the transferring power between the driving gear 120 and the driven gear 130 is transferred via the connecting component 132.

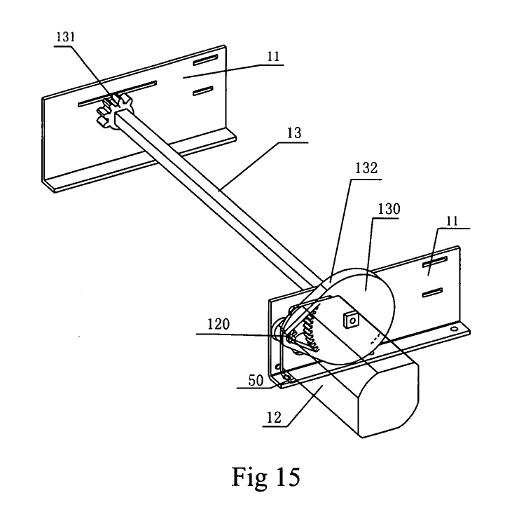

Differ from FIG. 14, a motor bracket 50 is added in the driving transmission frame 100 of the fifteenth embodiment shown in FIG. 15. The motor bracket 50 is set between the transmission shaft bracket 11 and the motor 12, the motor 12 is set on the motor bracket 50, the driving gear 120 and the driven gear 130 are set between the motor bracket 50 and the transmission shaft bracket 11, and the connecting component 132 connects the driving gear 120 with the driven gear 130.

which may be understood is that the electric punch device further includes a group of reamers and a driving board in above-mentioned embodiments, wherein the reamers are set on the driving board and the driving board cooperates with the transmission shaft 13, and the driving board drives the reamers to move up and down to punch basing on the driving of the transmission shaft 13.

What are disclosed above only are the preferred embodiments of the present invention, and therefore it is intended that the present invention not be limited to the particular embodiments disclosed. So it will be understood by those skilled in the art that various equivalent changes may be made depending on the specification and the drawings of present invention without departing from the scope of the present invention.

What is claimed is:

1. An electric punching device, comprising:
a driving transmission frame comprising a driving device and a transmission device, wherein the driving device comprises a motor, the transmission device comprises a transmission shaft, a transmission shaft bracket and a transmission component, and the transmission component is driven by the motor and drives the transmission shaft to turn and the transmission shaft is set on the transmission shaft bracket;
a group of reamers; and
a driving board cooperating with the transmission shaft, the reamers being set on the driving board.

2. The electric punching device as claimed in claim 1, wherein the transmission component comprises an active component and a passive component, and the transmission of the transmission component is a gear transmission, a chain transmission, a strap transmission, a screw transmission or a cam lever transmission.

3. The electric punching device as claimed in claim 2, wherein the transmission component is a cylindrical gear, a conical gear, a worm, a gear train, an assembly of gear and strap or an assembly of gear and chain.

4. The electric punching device as claimed in claim 2, wherein the motor is set on the transmission shaft bracket to drive the active component, the active component drives the passive component, and the active component cooperates with the transmission shaft to drive the transmission shaft to turn.

5. The electric punching device as claimed in claim 2, wherein the driving device further comprises a motor bracket, and the motor is set on the motor bracket to drive the active component set on the motor bracket or on the transmission shaft bracket.

6. The electric punching device as claimed in claim 4, wherein the active component and the motor are set on two sides of the transmission shaft bracket respectively, the motor drives the active component, and at least part of the passive component is set on the transmission shaft near to the transmission shaft bracket and cooperates with the active component.

7. The electric punching device as claimed in claim 5, wherein the active component and the motor are set on two sides of the transmission shaft bracket respectively, and the passive component is set on one end of the transmission shaft and cooperates with the active component.
